(19) United States
(12) Patent Application Publication
(10) Pub. No.: US 2008/0225770 A1
(43) Pub. Date: Sep. 18, 2008

(54) Method and System for Transmitting and Receiving Ethernet Data to and From Mobile Terminal Supporting High Speed Mobility

(76) Inventors: Jai-Hyung Cho, Daejeon-city (KR); Sungsoo Kang, Daejeon-city (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 11/994,733

(22) PCT Filed: Dec. 8, 2006
(86) PCT No.: PCT/KR2006/005312

§ 371 Date: Jan. 4, 2008

(30) Foreign Application Priority Data
Dec. 8, 2005 (KR) 10-2005-0120056
Jul. 28, 2006 (KR) 10-2005-0071651

(51) Int. Cl. H04J 15/00

(52) U.S. Cl. 370/312

(57) ABSTRACT

A method and a system for transmitting and receiving Ethernet data to/from a mobile terminal supporting high speed mobility are provided. The method includes: setting a wireless link between a specific access point among a plurality of wireless access points and the mobile terminal and registering identification information of the mobile terminal in the specific access point; allowing the specific access point to transmit an upward Ethernet frame received from the mobile terminal through the wireless link to the service node through the multicast tunnel connected to the specific access point; allowing the service node to recognize whether the mobile terminal is moving and to recognize a multicast tunnel address and identification information of the mobile terminal; allowing the service node to transmit the upward Ethernet frame to an external terminal, receive a downward Ethernet frame corresponding to a response to the upward Ethernet frame, and transmit the received downward Ethernet frame to the plurality of access points connected to the multicast tunnel; and allowing the specific access point, in which the identification information of the mobile terminal is registered, among the plurality of access points that receive the downward Ethernet frame to transmit the downward Ethernet frame to the mobile terminal. Accordingly, when the mobile terminal moves in a wireless LAN environment in which Ethernet data is transmitted and received to and from the mobile terminal, a soft hand-over in which service is not stopped and is stably maintained is provided.

### TECHNICAL FIELD

The present invention relates to a method and a system for transmitting and receiving Ethernet data to/from a mobile terminal supporting high speed mobility, and more particularly to a method and a system for transmitting and receiving Ethernet data supporting a soft hand-over in which service is not stopped and is stably maintained in wireless LAN environments.

### BACKGROUND ART

Existing methods for supporting mobility of a mobile terminal include a method of performing a hand-off process to allow direct transmitting and receiving of information on the mobile terminal for neighboring base stations or neighboring access points. A plurality of domestic and foreign patents about methods similar to the aforementioned methods have been opened to the public. For example, according to a method disclosed in Korean Patent No. 1998-064802, when the moving terminal deviates from an area served by a first access point and moves to a area served by a second access point, the first access point transmits control information needed for setting a wireless communication link with a mobile terminal to the second access point through a backbone network of LAN. The second access point resets the wireless communication link with the mobile terminal. The mobile terminal cuts the wireless communication link with the first access point and completes the hand-off process allowing the transmitting and receiving data by using only the second access point.

A problem of the hand-off method in a wireless LAN environment is that the hand-off process for transmitting and receiving the control message between the first and second access points is complex, a delay occurs between hand-offs, and accordingly a data loss or pause may occur in streaming communications in which quality while moving is sensitive. A technique capable of minimizing pauses during a hand-off process and ensuring steady data flow while moving is referred to as a soft hand-off.

In the existing technique for performing a soft hand-off in a wireless LAN environment based on Ethernet, the mobile terminal transmits an Ethernet control message including information on the second access point to which the mobile terminal is to move to, to a node performing a hand-off agent function in a wireless LAN environment. The hand-off agent node that receives a hand-off initiating message sets a multicast forwarding status capable of performing a bi-cast in which the hand-off initiating message is copied and transmitted to the first access point where the mobile terminal currently exists and the second access point to which the mobile terminal is to move to, in a MAC forwarding table of its own. Accordingly, the mobile terminal can receive necessary data without pauses, regardless of where the mobile terminal is located within the area of the first access point or the area of the second access point. However, the problem of the published Japanese Patent to which this description relates is that the information on the access point to which the terminal is to move to has to be initially recognized and transmitted to the hand-off agent node and it is difficult to initially recognize the aforementioned information due to various factors such as a change of receiving status of electric waves and a moving speed of the terminal in a real situation, and a service pause may be caused by transmission of wrong information if the point to which the terminal is to move to is incorrectly estimated. In addition, in the aforementioned invention, a known soft hand-off technique using an IP control message in a mobile IP network is simply applied.

A method using a multicast tree tunnel among existing methods of performing soft hand-off may be described by using hand-off processes in a case where an existing soft hand-off method using the multicast tree tunnel illustrated in FIG. 1 is applied to a wireless LAN environment.

In a wireless LAN environment illustrated in FIG. 1, a plurality of access points are connected to established multicast tunnels in which a service node 110 that functions as a foreign agent (hereinafter, referred to as FA) for a mobile terminal 180 is determined as a root node. The data transmitted by the root node is copied by intermediate nodes constituting the multicast tunnel and transmitted to a plurality of branch nodes. In FIG. 1, the mobile terminal 180 located in a service area of a first access point 160 stores address information of the mobile terminal in the first access point 160 through a physical registration process through a wireless link. The address information is also stored in the service node 110 through a separate process. When a fixed terminal 100 located in a wired backbone network segment transmits data 130 to the mobile terminal 180, the data is transmitted to the service node 110 through the wired backbone network segment. The service node 100 encapsulates the received data by using a header 120 for multicast tunnel transmission and broadcasts the data to the plurality of access points by using the multicast tunnel.

First to third access points that receive the copied data through a multicast tunnel 150 remove the encapsulation header 120 for multicast tunnel transmission and extract a destination terminal address from the data transmitted by the source terminal. When the information on the destination terminal to which the data is to be transmitted is currently registered, the access points transmit the data to the mobile terminal 180 through the corresponding wireless link, or otherwise, the access points discard the data. Accordingly, in FIG. 1, since the information on the mobile terminal 180 is registered in only the first access point 160, the first access point transmits the data to the mobile terminal 180. The second and third access points 161 and 162 discard the data.

In FIG. 1, when the mobile terminal 180 deviates a service area of the first access point 160 and moves to a service area of the second access point 161, the mobile terminal 180 sets a new wireless link while maintaining the wireless link with the first access point 160. Then, the data 130 copied through the multicast tunnel is transmitted to the mobile terminal 180 through the first and second access points in duplicate. The mobile terminal checks that non-defective data is received through the second access point and cuts the wireless link with the first access point. Accordingly, though the terminal moves between the areas served by access points, the soft hand-off capable of maintaining steady wireless communication without loss or delay of data is performed.

A problem of the aforementioned soft hand-off method using the multicast tree tunnel is that resources are largely wasted since a multicast tunnel is previously established over a wide area to which the terminal is to move. That is, since the data to be transmitted to the mobile terminal is broadcasted to the plurality of access points using the multicast tunnel, the used bandwidth is largely wasted. In addition, when the multicast tree is not previously established in the access point that the mobile terminal approaches, the mobile terminal has to establish a new multicast tree or perform the hand-off process in which the mobile terminal searches for and registers a suitable multicast tree. Therefore, processing the hand-off control message in the process of switching the multicast trees is complicated. A transmission delay and a data loss are generated in the process.

### DISCLOSURE OF INVENTION

### Technical Problem

The present invention provides a method and a system for transmitting and receiving Ethernet data to/from a mobile terminal supporting high speed mobility capable of encapsulating a MAC frame of a terminal in a MAC-in-MAC manner, performing speedy hand-off by recognizing a location of an access point in which the mobile terminal is located, reducing waste of resources, and establishing a wireless LAN service network by using an Ethernet network to embody an economical wireless LAN moving network service.

### Technical Solution

According to an aspect of the present invention, there is provided a method of transmitting and receiving Ethernet data to/from a mobile terminal supporting high speed mobility, in a wireless LAN environment in which a service node is connected to a plurality of access points through a plurality of multicast tunnels, the method including: setting a wireless link between a specific access point among the plurality of access points and the mobile terminal and registering identification information of the mobile terminal in the specific access point; allowing the specific access point to transmit an upward Ethernet frame received from the mobile terminal through the wireless link to the service node through the multicast tunnel connected to the specific access point; allowing the service node to recognize whether the mobile terminal is moving and to recognize a multicast tunnel address and identification information of the mobile terminal; allowing the service node to transmit the upward Ethernet frame to an external terminal, receive a downward Ethernet frame corresponding to a response to the upward Ethernet frame, and transmit the received downward Ethernet frame to the plurality of access point connected to the multicast tunnel; and allowing the access point, in which the identification information of the mobile terminal is registered, among the plurality of access points that receives the downward Ethernet frame to transmit the downward Ethernet frame to the mobile terminal.

In the above aspect of the present invention, the allowing the access point to transmit the downward Ethernet frame to the mobile terminal may include determining the specific access point setting the wireless link with the mobile terminal, in which the identification information of the mobile terminal is registered, to be a main branch of the plurality of access points that are connected to the multicast tunnel, and determining the two nearest access points to the main branch to be neighbor branches, to receive the downward Ethernet frame, and allowing the access point in which the identification information of the mobile terminal is registered to transmit the downward Ethernet frame to the mobile terminal.

According to another aspect of the present invention, there is provided a system for transmitting and receiving Ethernet data to/from a mobile terminal supporting high speed mobility, in a wireless LAN environment in which a service node is connected to a plurality of access points through a plurality of multicast tunnels, the system including: an upward transmitter in which a specific access point among the plurality of access point sets a wireless link with the mobile terminal, registers identification information of the mobile terminal, and transmits an upward Ethernet frame received from the mobile terminal to the service node through the multicast tunnel connected to the specific access point; a downward transmitter in which the access point, in which the identification information of the mobile terminal is registered, among the plurality of access points transmits the downward Ethernet frame to the mobile terminal; and a service node which recognizes whether the mobile terminal is moving, recognizes a multicast tunnel address and identification information of the mobile terminal, transmits the upward Ethernet frame to an external terminal, receives a downward Ethernet frame corresponding to a response to the upward Ethernet frame from the external terminal, and transmits the received downward Ethernet frame to the plurality of access points connected to the multicast tunnel.

In the above aspect of the present invention, each access point may include a memory cache capable of storing the tunnel address and the identification information of the mobile terminal.

According to another aspect of the present invention, there is provided a small-scale multicast tree used for the aforementioned system for transmitting and receiving Ethernet data of a mobile terminal supporting high speed mobility, the small-scale multicast tree including: an upward transmitter in which a specific access point among the plurality of access point sets a wireless link with the mobile terminal, registers identification information of the mobile terminal, and transmits an upward Ethernet frame received from the mobile terminal to the service node through the multicast tunnel connected to the specific access point; and a downward transmitter in which the access point in which the identification information of the mobile terminal is registered among the plurality of access points transmits the downward Ethernet frame to the mobile terminal.

### ADVANTAGEOUS EFFECTS

As a result of the aforementioned embodiment of the present invention, since MAC-in-MAC header information and a function of learning a MAC address of an Ethernet switch device are used, a speedy hand-off can be performed as compared with a method of performing a hand-off using an existing control message for performing a soft hand-off in a LAN environment.

In addition, since unnecessary hand-off information stored in an internal memory cache is automatically deleted by using a common ageing algorithm of an Ethernet switching device, the hand-off process is simplified.

In addition, waste of resources is reduced by transmitting data using a plurality of small-scale multicast tunnels, as compared with an existing soft hand-off method using large-scale multicast tunnels.

### DESCRIPTION OF DRAWINGS

FIG. 1 is a schematic view for illustrating a method of a soft hand-over by using an existing multicast tree tunnel supporting mobility of a terminal in wireless environments;

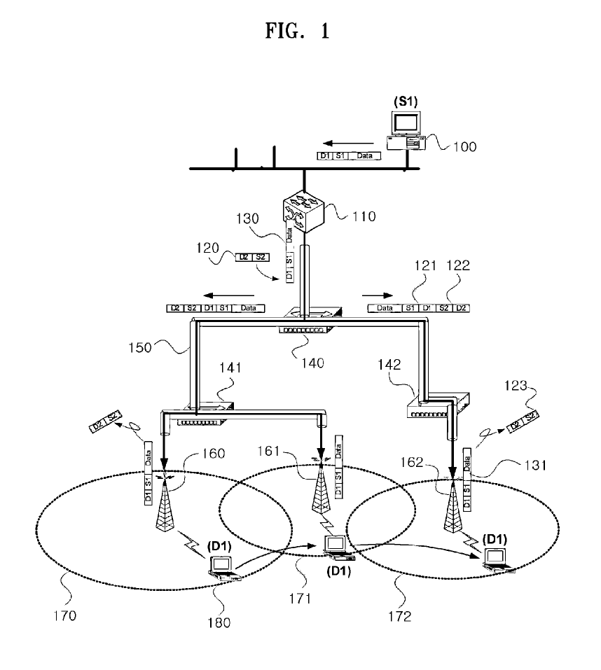

FIG. 2 is a schematic view for illustrating a method of a soft hand-over when a mobile terminal moves between areas served by two access points;

FIG. 3 is a schematic view for illustrating a status of the mobile terminal after the mobile terminal completes moving between the areas served by the two access points in FIG. 2 according to an exemplary embodiment of the present invention;

FIG. 4 is a view for illustrating procedures of a soft hand-off according to an exemplary embodiment of the present invention;

FIG. 5 is a flowchart for illustrating an algorithm for processing a service node according to an exemplary embodiment of the present invention;

FIG. 6 is a flowchart for illustrating an algorithm for processing an access point according to an exemplary embodiment of the present invention;

FIG. 7 is a view for illustrating a structure of MAC-in-MAC encapsulation frame according to an exemplary embodiment of the present invention;

FIG. 8 is a view for illustrating a system for transmitting and receiving Ethernet data to/from a mobile terminal supporting high speed mobility in wireless LAN environments according to an exemplary embodiment of the present invention; and

FIG. 9 is a flowchart of procedures of transmitting and receiving Ethernet data to/from a mobile terminal supporting high speed mobility in wireless LAN environments according to an exemplary embodiment of the present invention.

### BEST MODE

According to an aspect of the present invention, there is provided a method of transmitting and receiving Ethernet data to/from a mobile terminal supporting high speed mobility, in a wireless LAN environment in which a service node is connected to a plurality of access points through a plurality of multicast tunnels, the method including: setting a wireless link between a specific access point among the plurality of access points and the mobile terminal and registering identification information of the mobile terminal in the specific access point; allowing the specific access point to transmit an upward Ethernet frame received from the mobile terminal through the wireless link to the service node through the multicast tunnel connected to the specific access point; allowing the service node to recognize whether the mobile terminal is moving and to recognize a multicast tunnel address and identification information of the mobile terminal; allowing the service node to transmit the upward Ethernet frame to an external terminal, receive a downward Ethernet frame corresponding to a response to the upward Ethernet frame, and transmit the received downward Ethernet frame to the plurality of access point connected to the multicast tunnel; and allowing the access point, in which the identification information of the mobile terminal is registered, among the plurality of access points that receives the downward Ethernet frame to transmit the downward Ethernet frame to the mobile terminal.

In the above aspect of the present invention, the allowing the access point to transmit the downward Ethernet frame to the mobile terminal may include determining the specific access point setting the wireless link with the mobile terminal, in which the identification information of the mobile terminal is registered, to be a main branch of the plurality of access points that are connected to the multicast tunnel, and determining the two nearest access points to the main branch to be neighbor branches, to receive the downward Ethernet frame, and allowing the access point in which the identification information of the mobile terminal is registered to transmit the downward Ethernet frame to the mobile terminal.

In addition, the allowing the access point to transmit the downward Ethernet frame to the mobile terminal may further include transmitting the downward Ethernet frame from the access point corresponding to one of the neighbor branches, when the mobile terminal moves from a transmission area of the access point corresponding to the main branch to a transmission area of the access point corresponding to the neighbor branch.

In addition, the allowing the access point to transmit the downward Ethernet frame to the mobile terminal may further include allowing the access points that do not transmit the downward Ethernet frame to the mobile terminal to discard the downward Ethernet frame transmitted from the multicast tunnel.

In addition, allowing the specific access point to transmit an upward Ethernet frame may include encapsulating a tunnel header including information on whether the mobile terminal is moving, the multicast tunnel address, and the identification information of the mobile terminal and transmitting the encapsulated tunnel header to the service node.

In addition, allowing the service node to transmit the upward Ethernet frame to an external terminal may include encapsulating a tunnel header including the tunnel address and the identification information of the mobile terminal in the downward Ethernet frame and transmitting the encapsulated tunnel header to the plurality of access points.

According to another aspect of the present invention, there is provided a system for transmitting and receiving Ethernet data to/from a mobile terminal supporting high speed mobility, in a wireless LAN environment in which a service node is connected to a plurality of access points through a plurality of multicast tunnels, the system including: an upward transmitter in which a specific access point among the plurality of access point sets a wireless link with the mobile terminal, registers identification information of the mobile terminal, and transmits an upward Ethernet frame received from the mobile terminal to the service node through the multicast tunnel connected to the specific access point; a downward transmitter in which the access point, in which the identification information of the mobile terminal is registered, among the plurality of access points transmits the downward Ethernet frame to the mobile terminal; and a service node which recognizes whether the mobile terminal is moving, recognizes a multicast tunnel address and identification information of the mobile terminal, transmits the upward Ethernet frame to an external terminal, receives a downward Ethernet frame corresponding to a response to the upward Ethernet frame from the external terminal, and transmits the received downward Ethernet frame to the plurality of access points connected to the multicast tunnel.

In the above aspect of the present invention, each access point may include a memory cache capable of storing the tunnel address and the identification information of the mobile terminal.

According to another aspect of the present invention, there is provided a small-scale multicast tree used for the aforementioned system for transmitting and receiving Ethernet data of a mobile terminal supporting high speed mobility, the small-scale multicast tree including: an upward transmitter in which a specific access point among the plurality of access point sets a wireless link with the mobile terminal, registers identification information of the mobile terminal, and transmits an upward Ethernet frame received from the mobile terminal to the service node through the multicast tunnel connected to the specific access point; and a downward transmitter in which the access point in which the identification information of the mobile terminal is registered among the plurality of access points transmits the downward Ethernet frame to the mobile terminal.

### Mode for Invention

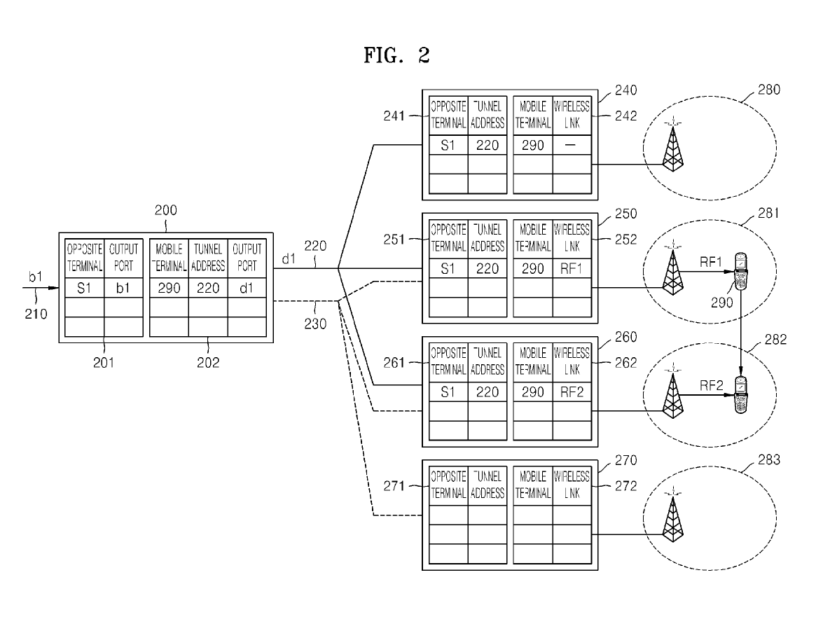

FIG. 2 is a diagram for illustrating a method of soft hand-over when a mobile terminal moves between areas served by two different access points.

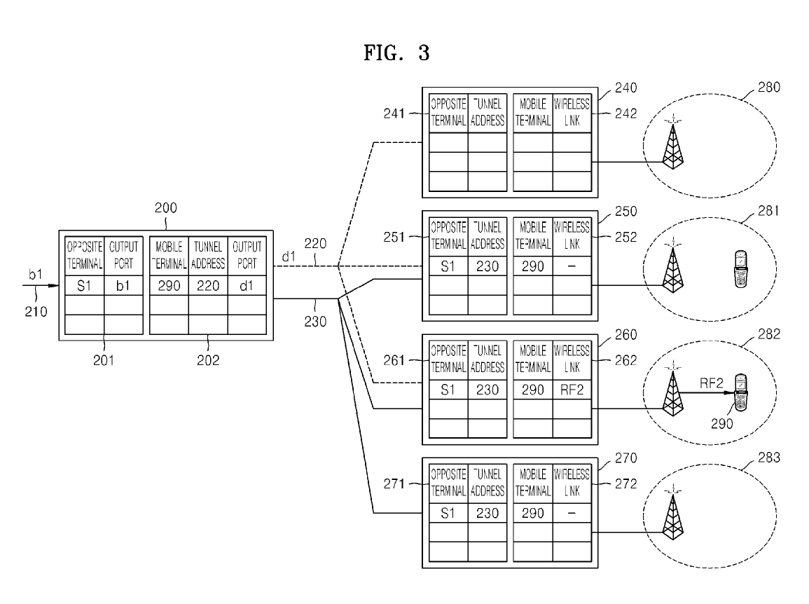

FIG. 3 is a diagram for illustrating a status of the mobile terminal after the mobile terminal completes moving between the areas served by the two different access points in FIG. 2 according to an exemplary embodiment of the present invention.

Accordingly, procedures corresponding to FIG. 2 and procedures to determine the status of the mobile terminal in which the mobile terminal completes moving are described collectively.

Referring to FIG. 2, a wireless LAN environment includes an Ethernet backbone network including a plurality of Ethernet devices and a wired Ethernet link, an Ethernet service node device 200, multi cast tunnels 220 and 230, and a plurality of wireless access points 280, 281, 282, and 283 serving predetermined cell areas. The service node 200 performing a foreign agent function in a wireless LAN communication network includes memory cache devices 201 and 202 capable of extracting and storing information on a mobile terminal through tunnels by using MAC header information of a received Ethernet frame. Similarly, the access points 280, 281, 282, and 283 include memory cache devices 241, 242, 251, 252, 261, 262, 271, and 272 capable of extracting and learning MAC header information of a received Ethernet frame and storing information on a mobile terminal. The service node 200 is connected to first to fourth access points 240 to 270 by using a plurality of Ethernet devices and wired Ethernet links. The service node 200 is connected to a plurality of Ethernet multicast tunnels according to the following method.

The Ethernet multicast tunnels 220 and 230 are paths through which a frame having an Ethernet multicast address is copied and transmitted from a root node to a plurality of branch nodes.

Each Ethernet multicast tunnel is established by determining the service node 200 as a root node and determining one access point and its neighboring access points as branches. For example, a first multicast tunnel 220 is established by determining the service node 200 as the root node and determining the second access point 250 and the neighboring first and third access points 240 and 260 as neighbor branches. Similarly, a second multicast tunnel 230 is established by determining the service node 200 as the root node and determining the third access point 260 and the neighboring second and fourth access points 250 and 270 as neighbor branches. Multicast tunnels are also established for the first and fourth access points 240 and 270, respectively. Accordingly, in a method of achieving soft hand-off in a mobile LAN network constructed by n number of access points, in total n number of small-scale Ethernet multicast trees are initially established.

Detailed processes in which a terminal 290 that is moving in the wireless LAN environment transmits and receives an Ethernet frame to and from any fixed terminal located in an Ethernet backbone network are described below.

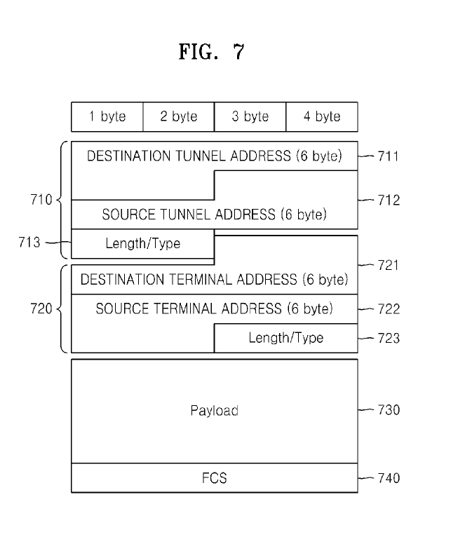

The mobile terminal 290 sets a wireless link through physical processes by accessing the second access point 250 and registers a MAC address in a memory cache 252 of the second access point 250. When an initial wireless link is set, the mobile terminal 290 generates and sends an initial message toward the service node for common DHCP procedures. The initial Ethernet frame transmitted by the mobile terminal 290 through the wireless link is transmitted to the second access point 250. The second access point 250 encapsulates the received Ethernet frame by using a first tunnel header in order to upwardly transmit the Ethernet frame through the established first multicast tunnel 220 in which the second access point 250 itself is used as the main branch. As shown in FIG. 7, an external MAC header for encapsulating the Ethernet data frame in a MAC-in-MAC manner through the first tunnel and transmitting the Ethernet data frame is the Ethernet MAC header 710 in which the MAC address of the service node 200 is set as a tunnel destination address 711, and the Ethernet multicast address of the first tunnel is set as the tunnel source address 712.

The second access point 250 upwardly transmits the MAC-in-MAC encapsulated Ethernet frame to the service node 200 through the first multicast tunnel 220. The service node 200 that receives the frame through the first multicast tunnel 220 extracts a MAC address of the mobile terminal 290, a tunnel address, and receive port information by using external and internal MAC header information of the MAC-in-MAC frame and stores the MAC address of the mobile terminal 290, the tunnel address, and the receive port information in the internal memory cache 202. Since all the tunnels are related to access points in one-to-one correspondence with each other, information on the current access point where the mobile terminal 290 is located can be obtained by using the stored tunnel information. The service node 200 according to an embodiment of the present invention learns the MAC address of the mobile terminal 290, the tunnel address, the access point information related to the tunnel, and the received port information by using the MAC-in-MAC header information of the Ethernet frame received from the access point and stores the MAC address of the mobile terminal, the tunnel address, the access point information related to the tunnel, and the received port information in the internal memory cache.

A process of downwardly transmitting a data frame transmitted from any fixed terminal located in the Ethernet backbone network to the mobile terminal 290 will now be described.

An Ethernet frame can be transmitted by any fixed terminal located in the Ethernet backbone network to the service node 200 through the Ethernet backbone network. The service node 200 can recognize that the target mobile terminal 290 is located in the area served by the second access point 250 connected through the first tunnel by extracting the target address from the Ethernet frame received from the backbone network and searching the embedded memory cache 202. Accordingly, the service node 200 MAC-in-MAC encapsulates the received Ethernet frame and downwardly transmits the MAC-in-MAC encapsulated Ethernet frame through the output port in order to broadcast the received Ethernet frame through the first multicast tunnel 220. As shown in FIG. 7, the MAC-in-MAC header used for downwardly broadcasting data through the first tunnel is the external MAC header in which the Ethernet multicast address of the first tunnel is set as the tunnel destination address 711, and the MAC address of the service node 200 is set as the tunnel source address 712.

The downwardly transmitted frame, transmitted through the first tunnel, is copied at the intermediate nodes constituting the multicast tunnel and transmitted to the first to third access points 240 to 260. Each of the access nodes which receives the frame through the first multicast tunnel 220 extracts the MAC address of an external fixed terminal and tunnel address information by using the external and internal MAC header information of the MAC-in-MAC frame and stores the MAC address of the external fixed terminal and tunnel address information in its own internal memory cache 241, 251, or 261. In addition, though currently the target mobile terminal 290 is not located in the service area of the access point that receives the MAC-in-MAC frame, the extracted MAC address information is initially stored in the internal memory cache 242, 252, or 262 of each access point since it is possible for the target mobile terminal 290 to move from the area of the neighboring access point to the service area of the access point in a short time. The information on the mobile terminal 290 and the information on an external terminal is stored in the internal cache memories of the first and third access points 240 and 260 adjacent to the second access point 250 where the mobile terminal 290 is currently located in addition to the second access point 250. According to an embodiment of the present invention, the access point where the mobile terminal 290 is currently located and the neighboring access points receive the Ethernet frame transmitted by the service node 200 through the same multicast tunnel, and the service node 200 learns the MAC address of the mobile terminal 290, the tunnel information, and the MAC address information of the external terminal communicating with the mobile terminal and store the MAC address of the mobile terminal, the tunnel information, and the MAC address information in their internal memory cache, respectively.

The second access point 250 that receives the Ethernet frame transmitted by the service node 200 transmits the received Ethernet frame to the mobile terminal 290 through the wireless link. Since in first and third access points 240 and 250 adjacent to the second access point 250 wireless links are not yet established for the target mobile terminal 290, the first and third access points 240 and 250 adjacent to the second access point 250 discard the received Ethernet frame.

The soft hand-off method according to an embodiment of the present invention can reduce waste of resources as compared with the existing soft hand-off method using a large-scale multicast tunnel by enabling the downward data transmitted toward the mobile terminal to be transmitted to only the access point where the mobile terminal is located and the neighboring access points.

When the mobile terminal 290 served by the second access point 250 moves to the area served by the third access point 260, the mobile terminal 290 sets a wireless link with the third access point 260 through a physical process and continuously receives the Ethernet frame transmitted by the external terminal without a pause through a stable wireless link among wireless links of the second and third access point. When the mobile terminal 290 completes moving to the area where the status of the wireless link with the third access point 260 is stable, the upward transmission of the Ethernet frame through the second access point 250 is stopped, and the Ethernet frame is upwardly transmitted only through the wireless link of the third access point 260. The third access point 260 extracts the destination MAC address from the received Ethernet frame and checks whether the information on the target external terminal is stored in the memory cache 261. When the mobile terminal 290 receives the frame transmitted by the external terminal up to that time through the first multicast tunnel 220, the information on the external terminal is stored in the first to third access points 240 to 260, in the same manner. Accordingly, the third access point 260 can recognize that the external terminal communicating with the mobile terminal reaches the area served by the third access point 260 through the first tunnel.

On the other hand, since the third access point is used as the main branch in the second multicast tunnel 230, the third access point encapsulates the data upwardly transmitted by the mobile terminal 290 in the MAC-in-MAC header for upwardly transmitting the data and transmits the encapsulated data to the service node 200. As shown in FIG. 7, the external MAC header for upwardly transmitting the Ethernet data frame through the second tunnel is the Ethernet MAC header in which the MAC address of the service node 200 is set as a tunnel destination address 711, and the Ethernet multicast address of the second tunnel is set as the tunnel source address 712.

The service node 200 that receives the MAC-in-MAC encapsulated frame from the second multicast tunnel 230 extracts the MAC address of the mobile terminal 290, the tunnel address, and the receive port information by using the external and internal MAC header information of the MAC-in-MAC frame and compares the MAC address of the mobile terminal 290, the tunnel address, and the receive port information by using the external and internal MAC header information of the MAC-in-MAC frame with the information stored in the internal memory cache 202. Then, the service node 200 recognizes that the mobile terminal 290 moves from the area served by the first access point to the area served by the second access point related to the second multicast tunnel 230. Accordingly, as shown in FIG. 3, the service node 200 updates the information on the mobile terminal 290 and the bound tunnel information in the internal memory cache 202. Thereafter, the service node 200 recognizes the status of the mobile terminal 290 and performs the hand-off by using the MAC-in-MAC header information of the Ethernet frame received from the access point.

The Ethernet frame transmitted by the external terminal communicating with the mobile terminal 290 is downwardly broadcasted through the second multicast tunnel 230, copied and transmitted to the second to fourth access points 250 to 270. The second to fourth access points 250 to 270 extract the MAC address of the external fixed terminal and the MAC address of the mobile terminal 290 communicating with the external fixed terminal, and the information on the tunnel address from the MAC-in-MAC header information of the received frame and compare the MAC address of the external fixed terminal and the MAC address of the mobile terminal 290 communicating with the external fixed terminal, and the information on the tunnel address with the information stored in the cache memories 251, 261, 271, 252, 262, and 272, respectively, thereby recognizing that the information on the external terminal and the bound tunnel information changes from the first tunnel to the second tunnel. Accordingly, when the wireless links between the second to fourth access points 250 to 270 and the mobile terminal 290 are still maintained, the received data is transmitted through a corresponding wireless link. The mobile terminal 290 cuts the wireless link with the second access point 250 which is maintained up to that time, immediately when the mobile terminal 290 checks that the non-defective data is received from the third access point 260. Therefore, the soft hand-off process can be completed without delay or loss of data while the mobile terminal 290 moves from the service area of the second access point to the service area of the third access point.

On the other hand, when the access points do not receive the upward data from the mobile terminal 290 and the downward data from the service node 200, the information stored in the internal memory cache is automatically deleted by a common ageing algorithm after a predetermined time has elapsed. Since the downward data is not transmitted through the first tunnel 220 after the mobile terminal 290 moves to the area served by the third access point 260, the information which the first access point 250 stores in the cache memories 241 and 251 is automatically deleted after the pre-determined time has elapsed. In addition, when there is no upward data transmission from the mobile terminal 290, the wireless link that the second access point 250 maintains is also cut after a predetermined time has elapsed, and the related link information is automatically deleted. When the service node and the access points according to an embodiment of the present invention do not receive the data upwardly transmitted from the mobile terminal and the data downwardly transmitted from the service node, the information stored in the internal memory cache is automatically deleted after the predetermined time has elapsed, and the corresponding wireless link is cut.

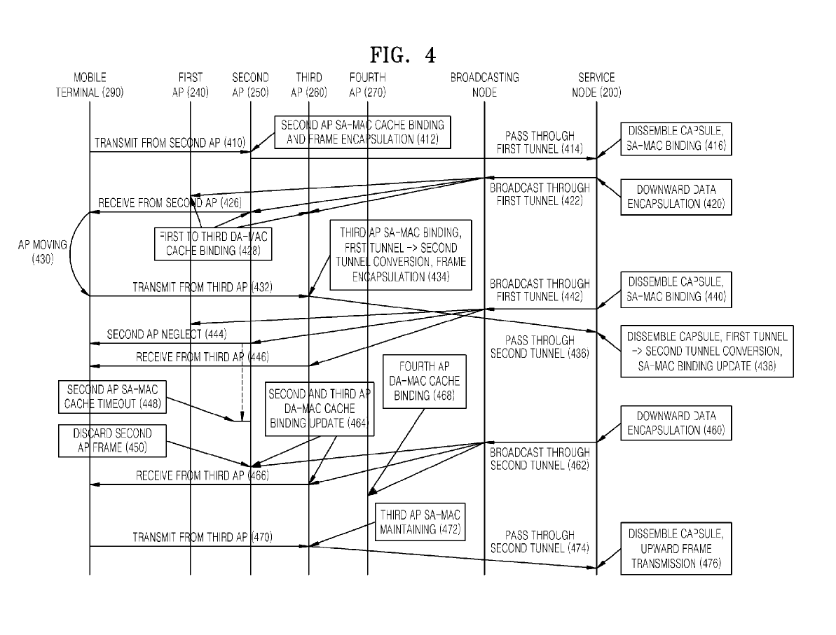

FIG. 4 is a diagram for illustrating procedures of a soft hand-off according to an exemplary embodiment of the present invention.

The mobile terminal 290 that approaches the second access point 250 sets the wireless link and registers the MAC address of the terminal (operation 410). The data generated by the mobile terminal 290 is transmitted to the service node 200 through the established first multicast tunnel 220 in which the second access point 250 is used as the main branch. Accordingly, the service node 200 learns the MAC address of the mobile terminal 290, binds the information in the first tunnel, and stores the bound information in the memory cache (operation 414).

An Ethernet frame can be transmitted by any fixed terminal located in the wired backbone network to the service node 200. The service node 200 can recognize that the frame has to be transmitted through the first multicast tunnel 220, from the information of the mobile terminal 290 stored in the aforementioned process. The service node 200 downwardly broadcasts the Ethernet frame through the first multicast tunnel 220. The copied data is transmitted to the first to third access points 240, 250, and 260 (operation 422). The access points that receive the copied data extracts the source MAC address of the Ethernet frame, binds the information in the external terminal and the first tunnel 220, and stores the bound information in the embedded memory cache (operation 422). Since only the second access point 250 among the access points that receive the copied data includes the information on the mobile terminal 290, the second access point 250 transmits the received Ethernet frame to the mobile terminal 290 through the wireless link (operation 426). The first and third access points 240 and 250 discard the Ethernet frame.

When the mobile terminal 290 moves from the area served by the second access point 250 to the area served by the third access point 260, the mobile terminal 290 sets the wireless link with the third access point 260 and registers the MAC address of the mobile terminal 290 (operation 432). The third access point 260 transmits the data generated by the mobile terminal 290 through the established second multicast tunnel 230 in which the third access point itself is used as the main branch. The service node 200 recognizes that the tunnel that can approach the mobile terminal 290 has changed from the first multicast tunnel 220 to the second multicast tunnel 230 and modifies the binding information of the mobile terminal 290 and the tunnel stored in the memory cache (operation 436).

Alternatively, when the external terminal firstly reaches the service node 200 before the Ethernet frame of the mobile terminal 290 is upwardly transmitted to the service node 200, since the service node 200 has not received the data of the mobile terminal 290 and has not updated the binding information yet, the data of the external terminal is downwardly broadcasted through the first multicast tunnel 220 (operation 442). Accordingly, the data copied through the first tunnel is transmitted to the first to third access points 240, 250, and 260. At this time, since the mobile terminal 290 sets the wireless link with the third access point 260 while maintaining the wireless link with the second access point 250, the mobile terminal 290 receives the same data from the second and third access points 250 and 260 (operations 444 and 446). The mobile terminal 290 cuts the wireless link with the second access point 250 immediately after the mobile terminal 290 has checked the mobile terminal 290 is receiving data from the third access point 260, and thus, the second access point 250 cannot receive data any more from the mobile terminal 290. The information of the mobile terminal 290 stored in the second access point is automatically deleted by the ageing function of the Ethernet switching device after the predetermined time has elapsed.

On the other hand, the service node 200 that receives the data transmitted by the mobile terminal 290 through the second multicast tunnel 230 binds the stored information of the mobile terminal 290 to the second multicast tunnel 230 and downwardly broadcasts the data received from the wired backbone through the second multicast tunnel 230 (operation 462). Though the data copied through the second multicast tunnel 230 is transmitted to the second to fourth access points 250 to 270, only the third access point 260 sets the wireless link with the mobile terminal 290, and accordingly, the data is transmitted to the mobile terminal 290 through the third access point 260 (operation 466).

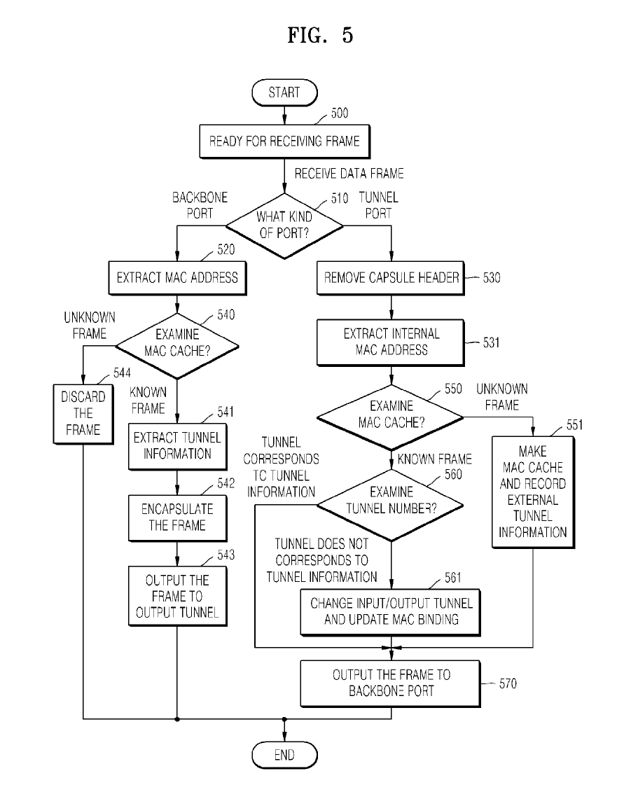

FIG. 5 is a flowchart for illustrating an algorithm for processing a service node according to an exemplary embodiment of the present invention.

The service node may receive an Ethernet frame through the Ethernet backbone network or receive the Ethernet frame from an access network in which a multicast tunnel is established (operation 500). When the service node receives the Ethernet frame through a port connected to the Ethernet backbone network, the service node firstly extracts a destination address from the Ethernet frame (operation 520) and searches an embedded memory cache (operation 540). When information on the destination address is not stored in the memory cache, the frame is discarded (operation 544), and the process is terminated.

When information on a mobile terminal corresponding to the destination address is found while the service node searches the embedded memory cache (operation 540), information on the current multicast tunnel bound to the mobile terminal is extracted (operation 541). The service node encapsulates the received Ethernet frame by using a tunnel header for downwardly transmitting the Ethernet frame to the corresponding tunnel (operation 542). The service node outputs the encapsulated frame through the corresponding output port in accordance with the extracted tunnel information (operation 570) and terminates the process.

When the service node receives the Ethernet frame through the port connected to the access network (operation 510), the service node firstly removes the tunnel header from the received frame (operation 530). The service node extracts MAC address information from the internal Ethernet frame from which the tunnel header is removed (operation 531). The service node checks whether the information on the mobile terminal or external terminal is stored in the memory cache by using the extracted MAC information (operation 550). When the aforementioned information is not present, the information on the mobile terminal, the information on the target terminal, and the received information of the tunnel are bound and stored in the embedded memory cache device (operation 551). The service node outputs the Ethernet frame received from the mobile terminal through the output port connected to the backbone network (operation 570) and terminates the process.

When the information on the mobile terminal is found while the service node searches the information stored in the memory cache (operation 550), it is checked whether the tunnel receiving the frame corresponds to the tunnel information bound to the mobile terminal (operation 560). When there is no change in the tunnel information, the received Ethernet frame is output through the output port connected to the backbone network (operation 570), and the process is terminated.

When the tunnel information currently bound to the mobile terminal does not correspond to the tunnel that receives the real frame while the service node searches the tunnel information stored in the memory cache (operation 560), the information on the mobile terminal is bound to the tunnel that receives the real frame, and the stored information is modified (operation 561). The service node outputs the received Ethernet frame through the output port connected to the backbone (operation 570) and terminates the process.

Accordingly, the service node terminates the processes of receiving the Ethernet frame, performing the soft hand-off, and broadcasting the frame.

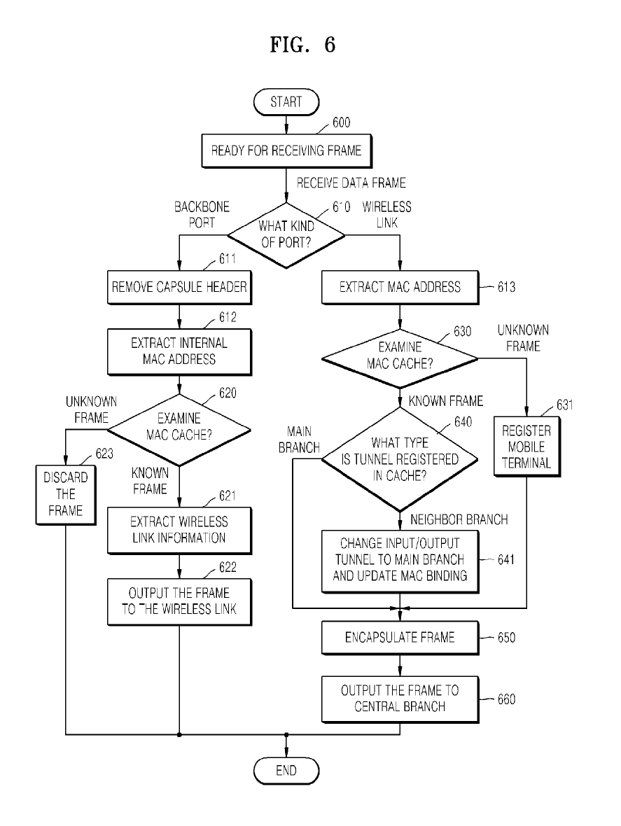

FIG. 6 is a flowchart for illustrating an algorithm for processing an access point according to an exemplary embodiment of the present invention.

An access point may receive an Ethernet frame from a wired LAN connected to the service node or receive the Ethernet frame from a wireless link connected to the mobile terminal (operation 600). When the access point receives the Ethernet frame from the wired port connected to the service node, the access point firstly removes the tunnel header from the Ethernet frame (operation 611). The access point extracts the MAC address information from the internal Ethernet frame from which the tunnel header is removed (operation 612). The access point checks whether the information on the mobile terminal or external terminal is stored in the memory cache by using the extracted MAC information (operation 620). When there is no aforementioned information, the received frame is discarded (operation 623), and the process is terminated.

When the information on the target mobile terminal access point is found while the access point searches the information stored in the memory cache (operation 620), the information on the wireless link connected to the terminal is extracted (operation 621). The access point outputs the received Ethernet frame through the wireless link (operation 622) and terminates the process.

When the access point receives the Ethernet frame through the wireless link (operation 610), the MAC address information is extracted from the received frame (operation 613). The access point checks whether the information on the mobile terminal or external terminal is stored in the memory cache by using the extracted MAC information (operation 630). When there is no aforementioned information, the access point stores the information on the mobile terminal, to which tunnel information in which the access point is used as the main branch is bound, in the embedded memory cache device (operation 631). The access point encapsulates the received Ethernet frame by using the tunnel header for upwardly transmitting the Ethernet frame to the central tunnel of which information is bound to the information on the mobile terminal (operation 650). The access point outputs the encapsulated frame through the wired port in which the central tunnel is established (operation 660) and terminates the process.

When the information on the target external terminal is found while the access point searches the information stored in the memory cache (operation 630), the tunnel information bound to the external terminal is extracted (operation 640). When the bound tunnel information corresponds to the central tunnel established at the access point, the access point encapsulates the received Ethernet frame by using the tunnel header for upwardly transmitting the Ethernet frame to the bound central tunnel (operation 650). The access point outputs the encapsulated frame through the wired port in which the central tunnel is established (operation 660) and terminates the process.

When the external terminal is not bound to the central tunnel that is established in the current access point in the process of checking the tunnel information bound to the external terminal (operation 640), the binding information stored in the memory cache is changed to the current central tunnel (operation 641). The access point encapsulates the received Ethernet frame by using the tunnel header for upwardly transmitting the Ethernet frame to the bound central tunnel (operation 650). The access point outputs the encapsulated frame through the wired port in which the central tunnel is established (operation 660) and terminates the process.

Accordingly, the access point terminates the processes of receiving the Ethernet frame, performing the soft hand-off, and broadcasting the frame.

FIG. 7 is a diagram for illustrating a structure of MAC-in-MAC encapsulation frame according to an exemplary embodiment of the present invention.

An Ethernet frame transmitted through a tunnel is encapsulated by using a MAC-in-MAC encapsulation method in which data frames 720, 730, and 740 to be transmitted through the tunnel are encapsulated in an external MAC header 710 and transmitted.

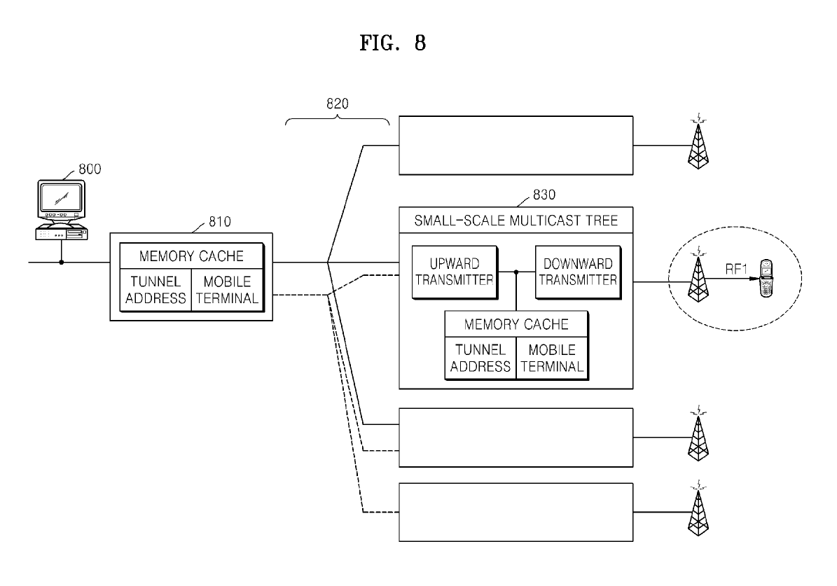

FIG. 8 is a diagram for illustrating a system for transmitting and receiving Ethernet data to/from a mobile terminal that supports high speed mobility in wireless LAN environments according to an exemplary embodiment of the present invention. Referring to FIG. 8, a system for transmitting and receiving Ethernet data to/from a mobile terminal includes an external terminal 800, a service node 810, a multicast tunnel 820, and a small-scale multicast tree 830 connected to an access point.

The external terminal 800, the service node 810, and the multicast tunnel 820 are the same as those shown in FIG. 2. The small-scale multicast tree 830 includes an upward transmitter, a downward transmitter, and a memory cache.

The upward transmitter transmits an upward Ethernet frame received from the mobile terminal to the service node through the multicast tunnel connected to the specific access point.

The downward transmitter transmits a downward Ethernet frame to the mobile terminal, at the access point, in which identification information of the mobile terminal is registered, among the plurality of access points.

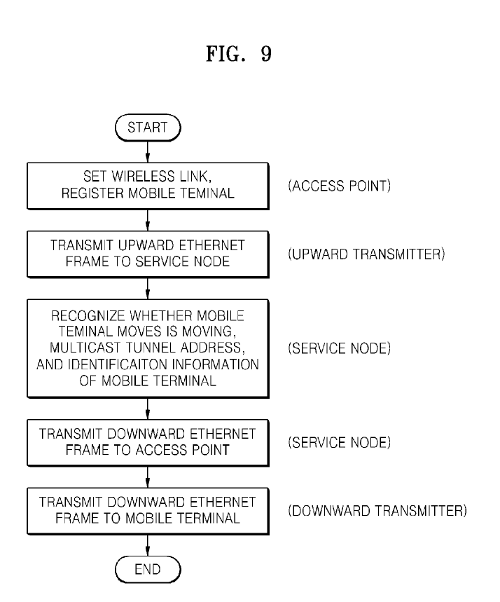

FIG. 9 is a flowchart for illustrating procedures of transmitting and receiving Ethernet data to/from a mobile terminal supporting high speed mobility in wireless LAN environments according to an exemplary embodiment of the present invention.

In the small-scale multicast tree, a wireless link with the mobile terminal is set, identification information of the mobile terminal is registered, an upward Ethernet frame is transmitted to the service node through the multicast tunnel connected to the specific access point, and the access point in which the identification information of the mobile terminal is registered transmits the downward Ethernet frame to the mobile terminal.

The service node recognizes whether the mobile terminal is moving, recognizes the multicast tunnel address, and the identification information of the mobile terminal, transmits the upward Ethernet frame to the external terminal, receives the downward Ethernet frame corresponding to a response to the upward Ethernet frame, and transmits the received downward Ethernet frame to the plurality of access points connected to the multicast tunnel.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

The present invention relates to a method and a system for transmitting and receiving Ethernet data to/from a mobile terminal supporting high speed mobility, and more particularly to a method and a system for transmitting and receiving Ethernet data supporting a soft hand-over in which service is not stopped and is stably maintained in wireless LAN environments.

1. A method of transmitting and receiving Ethernet data to/from a mobile terminal supporting high speed mobility, in a wireless LAN environment in which a service node is connected to a plurality of access points through a plurality of multicast tunnels, the method comprising:
(a) setting a wireless link between a specific access point among the plurality of access points and the mobile terminal, and registering identification information of the mobile terminal in the specific access point;
(b) allowing the specific access point to transmit an upward Ethernet frame received from the mobile terminal through the wireless link to the service node through the multicast tunnel connected to the specific access point;
(c) allowing the service node to recognize whether the mobile terminal is moving and to recognize a multicast tunnel address and identification information of the mobile terminal;
(d) allowing the service node to transmit the upward Ethernet frame to an external terminal, receive a downward Ethernet frame corresponding to a response to the upward Ethernet frame, and transmit the received downward Ethernet frame to the plurality of access point connected to the multicast tunnel; and
(e) allowing the access point, in which the identification information of the mobile terminal is registered, among the plurality of access points that receive the downward Ethernet frame to transmit the downward Ethernet frame to the mobile terminal.

2. The method of claim 1, wherein each access point comprises a memory cache capable of storing the multicast tunnel address and the identification information of the mobile terminal.

3. The method of claim 1, wherein the service node comprises a memory cache capable of storing the multicast tunnel address and the identification information of the mobile terminal.

4. The method of claim 1, wherein (e) comprises:
determining the specific access point setting the wireless link with the mobile terminal, in which the identification information of the mobile terminal is registered, to be a main branch of the plurality of access points that are connected to the multicast tunnel, and determining the two nearest access points to the main branch to be neighbor branches, to receive the downward Ethernet frame, and
allowing the access point in which the identification information of the mobile terminal is registered to transmit the downward Ethernet frame to the mobile terminal.

5. The method of claim 4, wherein (e) further comprises transmitting the downward Ethernet frame from the access point corresponding to one of the neighbor branches, when the mobile terminal moves from a transmission area of the access point corresponding to the main branch to a transmission area of the access point corresponding to the central branch.

6. The method of claim 4, wherein (e) further comprises allowing the access points that do not transmit the downward Ethernet frame to the mobile terminal to discard the downward Ethernet frame transmitted from the multicast tunnel.

7. The method of claim 1, wherein (b) comprises encapsulating a tunnel header including information on whether the mobile terminal is moving, the multicast tunnel address, and the identification information of the mobile terminal and transmitting the encapsulated tunnel header to the service node.

8. The method of claim 1, wherein (d) comprises encapsulating a tunnel header including the multicast tunnel address and the identification information of the mobile terminal in the downward Ethernet frame and transmitting the encapsulated tunnel header to the plurality of access points.

9. A system for transmitting and receiving Ethernet data to/from a mobile terminal supporting high speed mobility, in a wireless LAN environment in which a service node is connected to a plurality of access points through a plurality of multicast tunnels, the system comprising:
an upward transmitter in which a specific access point among the plurality of access points sets a wireless link with the mobile terminal, registers identification information of the mobile terminal, and transmits an upward Ethernet frame received from the mobile terminal to the service node through the multicast tunnel connected to the specific access point;
a downward transmitter in which the access point, in which the identification information of the mobile terminal is registered, among the plurality of access points transmits the downward Ethernet frame to the mobile terminal; and
a service node which recognizes whether the mobile terminal is moving, recognizes a multicast tunnel address and identification information of the mobile terminal, transmits the upward Ethernet frame to an external terminal, receives a downward Ethernet frame corresponding to a response to the upward Ethernet frame from the external terminal, and transmits the received downward Ethernet frame to the plurality of access points connected to the multicast tunnel.

10. The system of claim 9, wherein each access point comprises a memory cache capable of storing the multicast tunnel address and the identification information of the mobile terminal.

11. The system of claim 9, wherein the service node comprises a memory cache capable of storing the multicast tunnel address and the identification information of the mobile terminal.

12. The system of claim 9, wherein the multicast tunnel is constructed by determining the specific access point of the plurality of access points in which the mobile terminal sets the wireless link and registers the identification information as a main branch, and the two nearest access points to the main branch are determined as neighbor branches, and
wherein the access point, in which the identification information of the mobile terminal that receives the downward Ethernet frame is registered, transmits the downward Ethernet frame to the mobile terminal.

13. The system of claim 12, wherein when the mobile terminal moves from a transmission area of the access point corresponding to the main branch to a transmission area of the access point corresponding to one of the neighbor branches, the downward Ethernet frame is transmitted from the access point corresponding to the corresponding neighbor branch.

14. The system of claim 12, wherein the access points that do not transmit the downward Ethernet frame to the mobile terminal discard the downward Ethernet frame transmitted from the multicast tunnel.

15. The system of claim 9, wherein the upward transmitter encapsulates a tunnel header including information on whether the mobile terminal is moving, the multicast tunnel address, and the identification information of the mobile terminal and transmits the encapsulated tunnel header to the service node.

16. The system of claim 9, wherein the downward transmitter encapsulates a tunnel header including the multicast tunnel address and the identification information of the mobile terminal in the downward Ethernet frame and transmits the Ethernet frame to the plurality of access points.

17. A small-scale multicast tree in a wireless LAN environment in which a service node is connected to a plurality of access points through a plurality of multicast tunnels, the small-scale multicast tree comprising:
an upward transmitter in which a specific access point among the plurality of access points sets a wireless link with the mobile terminal, registers identification information of the mobile terminal, and transmits an upward Ethernet frame received from the mobile terminal to the service node through the multicast tunnel connected to the specific access point; and
a downward transmitter in which the access point in which the identification information of the mobile terminal is registered among the plurality of access points transmits the downward Ethernet frame to the mobile terminal.

18. A computer-readable recording medium having embodied thereon a computer program for executing the method of claim 1.
